(19) United States
(12) Patent Application Publication
(10) Pub. No.: US 2010/0236044 A1
(43) Pub. Date: Sep. 23, 2010

(54) DISC BRAKE PISTON RETRACTION TOOL

(76) Inventor: Steven D. Bearman, Mesa, AZ (US)

Correspondence Address: MARVIN A. GLAZER, 2141 E. HIGHLAND AVE, SUITE 155, PHOENIX, AZ, 85016, US

(21) Appl. No.: 12/407,655

(22) Filed: Mar. 19, 2009

(51) Int. Cl. B23P 11/00; B23P 19/04

(52) U.S. Cl. 29/428; 29/256

(57) ABSTRACT

A disc brake tool to assist brake maintenance by forcing retraction of a brake piston. Two plates are inserted into the open area of a brake caliper while a third central member is forced between the plates. A crank-rotatable threaded shaft engages the central member to control central member movement along the shaft. The plates engage the caliper directly or indirectly and force pressure on the outside of a piston to cause it to retract back into the caliper. A method is also disclosed for retracting a brake piston by placing plates within the open area of a caliper. The method includes rotating a shaft to cause a third member to press apart the plates so as to force pressure on a piston.

### FIELD OF THE INVENTION

The present invention relates generally to automobile brake maintenance. More particularly, the invention relates to servicing disc brakes including the replacement of disc brake pads.

### BACKGROUND OF THE INVENTION

Disc brake devices slow and stop the rotation of a wheel. Automobiles generally to come standard with two different braking systems, drum and disc brakes on alternating axles. Disc brakes are often utilized on the front axle of a car or motorcycle, and provide substantial braking power when applied to a wheel. In use, disc brakes operate to stop the wheel, by forcing brake pads (friction material mounted on the brake caliper) against both sides of a brake disc (also known as a “rotor”). Friction causes the disc, or rotor, to stop. The rotor being attached to the wheel controls the velocity of the vehicle.

A brake caliper is an assembly which houses the brake pads and piston(s). Calipers may be fixed or floating. A single-piston “floating” (or sliding) caliper is generally self-centering and self-adjusting. The floating caliper changes position relative to the disc along a line parallel to the axis of rotation of the rotor. A piston on one side pushes the inner brake pad until it makes contact with a braking surface, then pulls the caliper body with the outer brake pad so that pressure is applied to both sides of the disc. The caliper is free to float back and forth on the wheel brake to ensure that the brake is centered on the wheel. There is generally no spring to pull the brake pads, which contact the disc, so the pads stay in light contact with the disc. Furthermore, the piston will adjust to extend to contact the disc so as to allow a more consistent requirement of brake fluid flow to apply a consistent braking power.

The most common caliper design uses a single hydraulically actuated piston within a cylinder, however higher braking power needs can lead to use of as many as a dozen pistons arranged singly or paired on both sides of the disc. Disc brakes come in all sizes and number of pistons. Brake pads are designed for high-friction with brake pad material embedded in the disc. Brake pads must usually be replaced regularly due to wear.

When replacing brake pads, it is usually required to disconnect the caliper from the wheel. Brake pads may then be free to slide out, however sometimes there may be a clip or spring holding the pad. Once the pads are out, it is necessary to push the piston(s) back into the caliper. Many methods have been designed to accomplish this task. For instance, a C-clamp may be used with one end positioned inside the caliper and the other on the outside of the caliper to compress the piston. This method is cumbersome and risks placing unwanted pressure on the outside of the caliper. Another method comprises putting an oval shaped tool into the caliper, and rotating this device until the long end holds the piston back. This method is dangerous for it requires much applied and specific force to accomplish. Other methods have been designed for single-piston brakes. Certain specific methods use a shaft inserted from the open end of the caliper to press on the piston and a second surface inside the caliper, for example see U.S. Pat. Nos. 5,018,261 to Markous and 6,523,238 to Priddy (requiring entry both from the open end and through an aperture in the caliper back wall, thus incapable of use with a dual-piston caliper). These methods are inadequate when direct access from a single direction is not easily attained.

Another known method includes access only through the open end, without requiring access from an aperture, however this method suffers from many drawbacks, including a lack of proper support or strength to properly manipulate these tools have proven less popular.

Other methods rely on a tool inserted into a region of the brake pads. Most of these methods use a very small contact area to engage the piston, and retain many of the drawbacks of other methods known in the art.

### OBJECTS OF THE INVENTION

It is therefore an object of the present invention to provide a tool to assist in positioning a caliper piston for replacement of brake pads whereby the user is free to enter at any direction.

It is a further object to provide piston retraction with access only through an open end of a caliper.

It is a yet further object of the present invention to provide a brake piston retraction tool that may be used on single as well as dual-piston systems.

It is yet another object to provide piston retraction with enough leverage power.

It is another object of the present invention to provide a tool with dual-plates to engage a caliper piston and a second surface.

It is yet another object of the present invention to provide a tool with plates broad enough to easily engage at least a caliper piston.

It is still another object of the present invention to provide a tool for easy piston retraction.

It is still yet another object of the present invention to safely retract or separate a misplaced item.

These and other objects of the present invention will become more apparent to those skilled in the art as the description of the present invention proceeds.

### SUMMARY OF THE INVENTION

According to one aspect of the present invention, an apparatus is provided for pushing back a disc brake caliper piston. A pair of arms are thin enough to be inserted within a disc brake caliper, whereby at least one of said pair of arms can engage the end of a brake piston, and the other arm can engage a second surface. The arms are loosely coupled to one another. A crank is provided to cause the pair of arms to separate when the crank is rotated in a single direction.

According to another aspect of the present invention, an apparatus is provided for pushing back a disc brake caliper piston. A pair of arms are thin enough to be inserted within a disc brake caliper, whereby at least one of said pair of arms can engage the end of a brake piston, and the other arm can engage a second surface. The arms are loosely coupled to one another at their bases so as to allow them freedom to move apart and closer to one another and also to rotate relative to one another about an axis, or axes defined between the two arms. The arms may be described so as to each have an interior surface and an exterior surface, whereby the exterior surfaces are for engaging surfaces of the disc brake caliper. One, or both, of the arms may be tapered so that the ends away from the bases have a gradual opening. The preferred embodiment may also contain a central member, preferably a wedge, set between the two arms, and the central member is adapted to move between the arms back and forth, from base to tip. One of the arms surface may also contain a dove-tail feature to secure the central member in place, and the central member has a complimentary surface to interact with the dove-tail.

A threaded shaft may be disposed through the central member, whereby rotating the threaded shaft causes the central member to move relative to the shaft. A crank can be attached to the threaded shaft for rotating the shaft. A connection plate, preferably with an aperture for receiving and maintaining the shaft, may loosely couple the pair of arms.

The present invention also provides an apparatus for retracting at least one piston of a disc brake caliper. A top finger and a bottom finger each have an interior surface, an exterior surface, a base at one end, and a tip at an opposing end. A central member is set between the top and bottom fingers for engaging the interior surfaces. The central member may be wedge-shaped with a broad portion of the wedge positioned towards the tip of at least one of the fingers. The central member may also include a threaded aperture to engage the threaded member.

The top and bottom fingers have substantially parallel longitudinal axes formed along each tip and base; and the central member is adapted to move between the arms, longitudinally back-and-forth, substantially parallel along the axes. A threaded member engages the central member wherein rotation of the threaded member forces contact between the central member and both of the top and bottom fingers. A crank may be coupled to the threaded member to rotate it. In the preferred embodiment, at least one of the top and bottom fingers has a dove-tail to fit with a complimentary surface on the central member to form a dove-tail joint.

The present invention also provides and apparatus for retracting at least one piston of a disc brake caliper, the caliper having at least one piston and a second surface disposed opposite the piston, wherein the caliper piston moves in a linear fashion defining a plane perpendicular to the movement of the caliper piston. The apparatus is a threaded shaft disposed substantially along the plane perpendicular, whereby the shaft is initially free to rotate substantially within the plane perpendicular. A central member receives the shaft through its threaded aperture so that rotation of the shaft forces the central member to move along the shaft and by doing so, forces the piston to retract. The apparatus may have a top and bottom arm, each having a tip at one end and a base at an opposing end, and having an interior surface and an exterior surface, the interior surfaces facing one another with the shaft positioned there between, and wherein rotation of the shaft forces the central member to engage the arms' interior surfaces. It may do so by causing the central member to force a portion of the top and bottom arms apart from one another, causing their exterior surfaces to engage the caliper piston.

The present invention also provides a method of controlling a caliper piston position. Two plate members are inserted between an exposed caliper piston and a second surface. A central member is forced there between in order to force the plate members to engage the caliper piston and the second surface by forcing the plate members apart form one another so as to cause at least one of the plate members to push on the caliper piston. This method may include forcing two caliper pistons back simultaneously. The method may also be performed via activating and rotating a rotating a threaded member and may pull the central member towards a base of the two plate members.

### BRIEF DESCRIPTION OF THE DRAWINGS

The present invention may more readily be understood by reference to the accompanying drawings in which:

FIG. 1 is a perspective view of an embodiment of the invention;

FIG. 2 is an elevational view along Line 2-2 showing the cross-section of FIG. 1;

FIG. 3 is a partial cross-sectional view along Line 3-3 of FIG. 2;

FIG. 4 is an exploded partial view of the apparatus of FIG. 1;

FIG. 5 is a cross-sectional view along Line 5-5 of FIG. 1;

FIG. 6 is a top view along Line 6-6 of FIG. 5;

FIG. 7 is a cross-sectional view along Line 7-7 of FIG. 5;

FIG. 8 is an enlarged partial view of area 8 of FIG. 5;

FIG. 9 is a perspective view of an alternate embodiment of the invention;

FIG. 10 is a partial exploded view of the apparatus shown in FIG. 9.

### DETAILED DESCRIPTION OF THE PREFERRED EMBODIMENTS

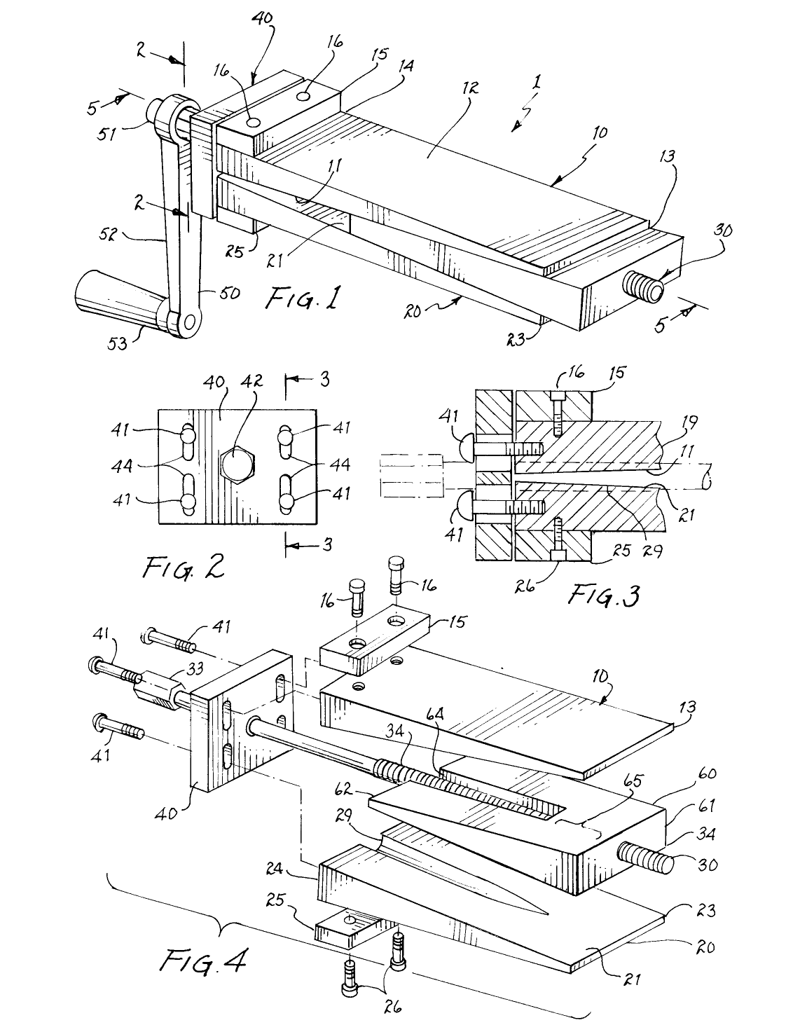

Referring first to FIGS. 1-4, an embodiment of the invention is shown as a brake tool. In the preferred embodiment, brake tool 1 has top plate 10 positioned directly over bottom plate 20. Top plate base 14 is aligned with bottom plate base 24. Top plate interior surface 11 and/or bottom plate interior surface 21 may be tapered towards top and bottom plate tips 13 and 23 so as to create a broadening opening towards the tips. Central member 60 is preferably set between plates 10 and 20. Central member 60, also referred to and shaped as a “wedge” in the preferred embodiment, may be free-floating, out of contact with either of the plates. Wedge 60 is positioned with narrow portion 62 pointing towards plate bases 14 and 24 and connection plate 40. Broad portion 61 of the wedge 60 points away from connection plate 40. Shaft 30 may serve to support wedge 60. In the preferred embodiment, shaft 30 is a threaded screw member with threads 34 to engage wedge 60, whereby rotation of shaft 30 causes a force on wedge 60 to move the wedge longitudinally along the shaft's length.

Top plate 10 has exterior surface 12 to engage a portion of the brake caliper (not shown), such as a piston head. Exterior surface 12 is preferably large and flat to maximize the surface area contact with the caliper. Bottom plate 20, also has exterior surface 22 for similar purpose.

Connection plate preferably fits perpendicularly along bases of top and bottom plates 10 and 20. Connection plate 40 has slots 44 to accept complementary coupling fasteners 41. Coupling fasteners are attached directly or indirectly to the top and/or bottom plates through the connection plate. This loosely couples the connection plate to the plates, allowing the top and bottom plates to move relative to one another. Generally, slots 44 allow vertical movement of coupling fasteners 41. Aperture 42 is preferably at or near the center of the connection plate. Aperture should be wide enough to accept shaft 30. Supports 15 and 25 may be added to further secure top and bottom plates 10 and 20, respectively. Support fasteners 16 and 26 serve to preferably permanently secure supports to the top and bottom plates.

Shaft 30 is preferably fitted with hex base 33 for mounting crank 50. Hex base is preferably on a first side of the connection plate. Shaft extends through aperture 42 to other side of the connection plate. Threads 34 extend along a portion of shaft 30, but preferably only on the front end 31. Crank 50 has fitting 51 to mate with shaft 30. Crank 50 uses bar 52 to provide leverage enough to convert power along shaft 30 to promote movement of wedge 60. Further, handle 53 allows for manipulation of crank 50, to facilitate rotation of shaft 30, thus causing central member 60 along shaft 30 to force plates 10 and 20 against caliper surfaces. Handle 53 may be perpendicular to bar 52 and may be a separate piece that is pivotally connected to bar 52 for allowing manipulation of crank 50. Handle 53 can include other embodiments wherein the handle is permanently affixed to bar 52, or any other way known in the art for handles.

Wedge 60 has wide portion 61 directed towards tips 13 and 23 of plates 10 and 20, and narrow portion 62 towards the base. Top and bottom plates 10 and 20 are preferably tapered so that they provide a large opening towards the tips for placement of a wedge or like structure. Threads 34 engage complementary surface within torque zone 65. As shaft 30 turns, mechanical forces pull or push wedge 60 longitudinally along shaft. Wedge top surface 67 engages the top plate and bottom surface 68 engages bottom plate. Movement of wedge 60 in between the top and bottom plates surfaces causes top and bottom plate interior surfaces 11 and 21 to move relative to one another and thus force piston back. When central member 60 is wedge shaped, the thickness of the wedge may at some point become thinner than shaft 30. For this reason, open area 64 is built into wedge 60 to allow for shaft 30. Top and bottom plates 10 and 20 therefore contain recesses, grooves, or pass-throughs 19 and 29 formed towards bases 14 and 24, on interior surfaces 11 and 21.

FIGS. 5-8 demonstrate the interior mechanisms of the preferred embodiment. Shaft 30 preferably extends longitudinally along the entire length of the plates. Top and bottom plates are tapered to allow a larger opening away from connection plate 40. Torque region 65 of wedge 60 is the portion of the wedge that contains complementary or even threaded interior surface to allow rotation of mated shaft to cause the wedge to move longitudinally along shaft 30. Clip 43 may be provided along shaft 30 and nearby or around connection plate 40, to secure shaft and crank to the connection plate and altogether hold the apparatus together.

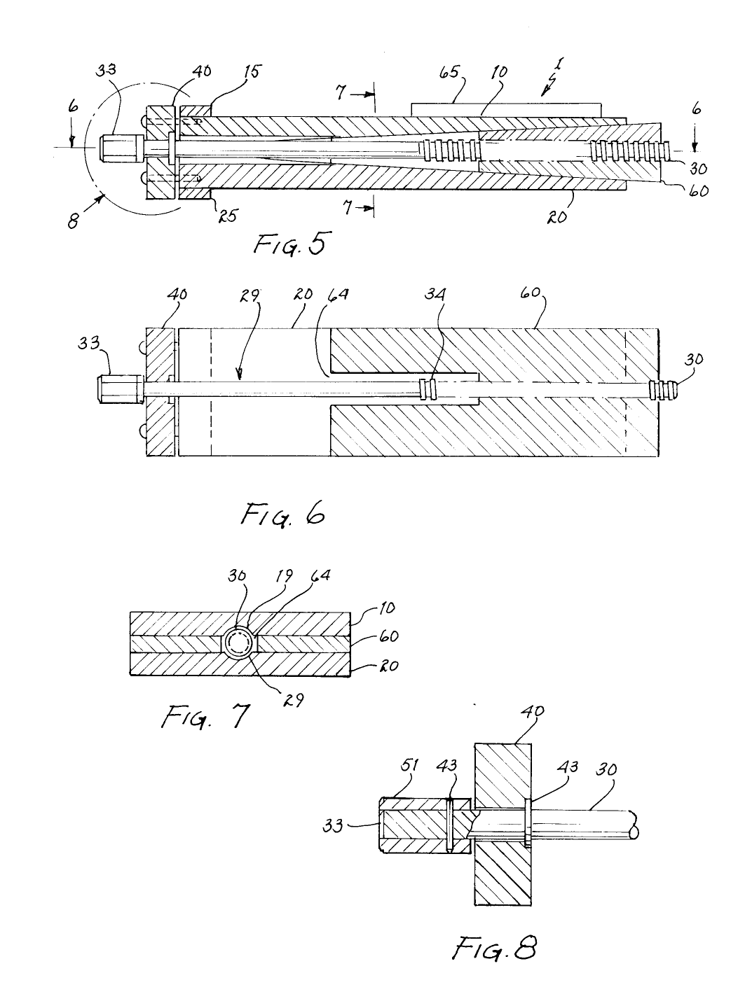

Referring to FIG. 6, open area 64 of the central member is shown. Open area does not contain the complementary surface to contact threads 34 of the shaft. Bottom plate 20 is equipped with pass-through recess 29 to allow tapering of the bottom plate without interference with the shaft.

Referring to FIG. 7, top plate 10 and bottom plate 20 surround a central member, preferably a wedge-shaped piece, or wedge 60. Shaft 30 fits between the plates and within recesses 19 and 29 along open area 64.

Referring to FIG. 8, connection plate 40 allows shaft 30 through. Clips 43 are provided to secure longitudinal position of shaft 30 in relation to connection plate 40. Hex base 33 of the shaft is over-fitted with crank fitting 51. In the preferred embodiment, fitting 51 surface complements hex base configuration, however, any permanent or temporary fitting or attachment mechanism may be used, as are known in the art.

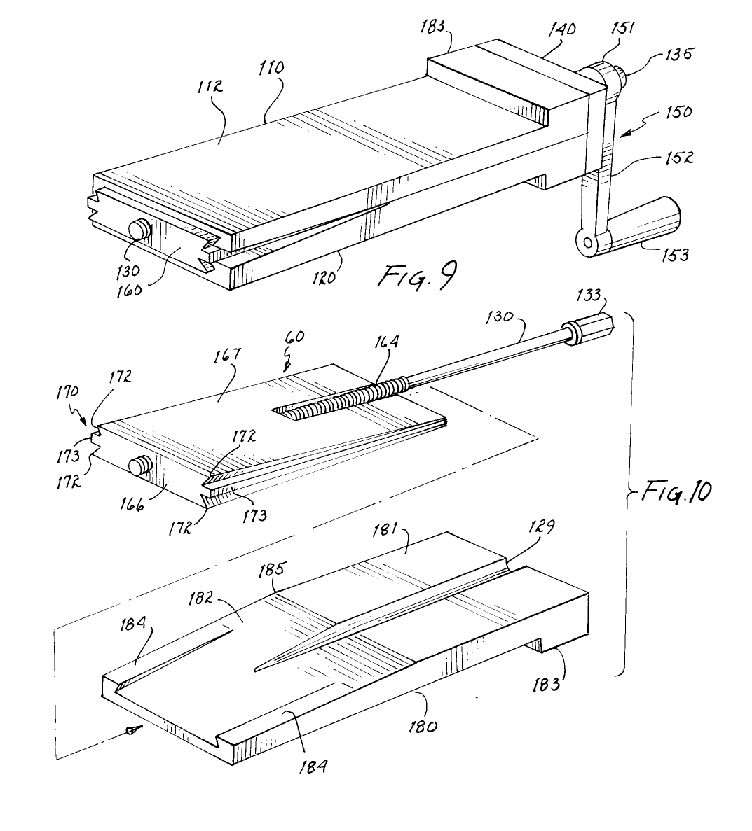

FIGS. 9 and 10 demonstrate another preferred embodiment of the invention. Brake tool 100 has top plate 110 with support bar 183 at its base. Support bar 183 may be used instead of supports or may be included for aesthetic purposes. Connection plate 140 is positioned at the base of the device and may or may not remain in this preferred embodiment, or may be part of a crank support. Shaft base 135 here is of a round shape, rather than a hex shape, and may form any structure complementary to fitting 151. Crank 150 attached to shaft 130 such that rotation in a first direction causes shaft to rotate in a first direction, thus pulling wedge 160 in towards the base. Such pulling action forces wedge 160 between the plates and forces plates 110 and 120 apart from one another. When plates are forced apart, top exterior surface 112 and bottom exterior surface 122 (not shown) engage parts of a brake caliper, and may force a piston back. Rotating crank 150 in a second direction forces wedge 160 away from the base and allows plates to resume a position closer relative to one another.

Crank 150 has handle 152 to provide leverage. Crank handle 153 is useful to rotate the crank and is preferably large enough for manipulation by the hands or fingers of a mechanic. Handle 153 should be long enough to be gripped with enough force such that no counter pressure, or twisting is required. It is preferred that the brake tool will be held in place by either a second hand, or by pressures within the caliper such that a single hand may be used to run the crank.

Either or both exterior surfaces 112 or 122 (bottom mot shown) may be forced against a piston, and the invention is intended to be used right side up or upside down without any difference as to which of the top and bottom plates are positioned within the caliper.

Referring to FIG. 10, an alternate embodiment of the central member is shown. Shaft 130, with hex base 133 is shown. Shaft 130 enters through open area 164, into the aperture and emerges near the front panel 166. To accommodate dove-tailing, wedge complimentary surface 170 may include tapered joint wings 172, with support beam 173 placed there between. Joint wings 172 are complimented by dove-tails 184. Joint wings 172 are preferably tapered with maximum extension towards front surface 166, receding towards the base to a particular reflex point 174. At the reflex point, support beam 173 is inverted, along with the removal or reversal of the joint wings. This occurs relative to cross-line 185 to work with tapered region 182 of plate 180. Reflex point allows wedge 160 with dove-tailing joint wings to be inserted further in between plates, towards the base, so as to cause some or further separation of the plates. Central member 160 although preferably shaped as a wedge, may function in alternative shapes.

Plate 180 is identical on top and bottom of the device, therefore, for this embodiment, only one plate is demonstrated. Plate 180 preferably uses pass-through 129 to allow for placement of shaft 130 with enough room for shaft to freely rotate within pass-through. Plate has flat surface 181 on its interior for mating with another plate flat surface. At rest, with central member affixed towards tips or not affixed at all, surface 181 may be free to contact with its complement on a second plate. Wedge 160 fits into dove-tails 184 so that wedge complementary surface 170 engages plate 180 by its dove-tails. Dove-tails 184 recede along tapered region 182 and may end at or before cross-line 185.

Another aspect of the present invention relates to a method for engaging a brake caliper. Two plates 10 and 20 are inserted into the open end of a single or multiple pistoned disc brake caliper. No access should be required through a secondary aperture. Plates 10 and 20 are set to engage with at least one piston, that may have extended into the caliper give the wear of brake pads, or release of counter-pressure during maintenance, etc. One plate engages at least one piston, and the opposite plate is set against another surface of the caliper, or a surface placed within the caliper. Shaft 30 is manipulated, preferably by crank 50, to cause central member 60 between the plates 10 and 20. Interior surfaces 11 and 21 of plates 10 and 20 engage the exterior surfaces 67 and 68 of central member 60. As shaft 30 further causes central member 60 between plates 10 and 20, plates 10 and 20 are forced apart. Plates 10 and 20 then exert pressure on a piston, causing the piston to retract.

The present invention has been described in terms of selected specific embodiments of the invention incorporating details to facilitate the understanding of the principles of construction and operation of the invention. Such reference herein to a specific embodiment and details thereof is not intended to limit the scope of the claims appended hereto. It will be apparent to those skilled in the art that modifications may be made in the embodiments chosen for illustration without departing from the spirit and scope of the invention.

What is claimed is:

1. An apparatus for pushing back disc brake caliper pistons, the invention comprising:
a pair of arms to be disposed within a brake caliper, at least one of said pair of arms for engaging at least one brake piston, and the other of at least one of said pair of arms for engaging a second surface;
said pair of arms coupled to one another;
a rotatable crank causing said pair of arms to separate when rotated; and
a handle attached to said rotatable crank to allow manipulation.

2. An apparatus for pushing back disc brake caliper pistons, the invention comprising:
a pair of arms to be disposed within a brake caliper, at least one of said pair of arms for engaging at least one brake piston, and the other of at least one of said pair of arms for engaging a second surface;
each of said pair of arms comprising a base at one end and a tip at an opposing end;
said pair of arms coupled to one another along the bases of said arms;
wherein said pair of arms can be moved apart or towards each other; and
wherein said pair of arms are rotatable relative to one another.

3. The apparatus of claim 2 wherein each of said pair of arms comprises an interior surface and an exterior surface, said exterior surfaces for engaging parts of the disc brake caliper; and
wherein said at least one of the interior surfaces is angled so as to cause at least one of said arms to be tapered to be thicker at the base than at the tip so as to provide said pair of arms with an opening towards the tips.

4. The apparatus of claim 3 wherein said arms have substantially parallel longitudinal axes formed along each tip and base; and wherein said central member is adapted to move between said arms longitudinally back and forth substantially parallel along the axes.

5. The apparatus of claim 3 additionally comprising a central member disposed between said pair of arms.

6. The apparatus of claim 5 wherein said central member is wedge shaped.

7. The apparatus of claim 5 wherein said at least one of said interior surfaces comprises at least one dove-tail to secure said central member.

8. The apparatus of claim 7 wherein said central member comprises at least one complimentary surface to interact with said at least one interior surface dove-tail.

9. The apparatus of claim 5, additionally comprising a threaded shaft disposed through said central member, whereby rotating said threaded shaft causes said central member to move relative to said threaded shaft.

10. The apparatus of claim 9 additionally comprising a crank attached to said threaded shaft for rotating said shaft.

11. The apparatus of claim 9 additionally comprising a connection plate loosely coupled to said pair of arms.

12. The apparatus of claim 11 wherein said connection plate comprises an aperture, said connection plate aperture wide enough to allow said threaded shaft to rotate within said connection plate aperture.

13. The apparatus of claim 11 wherein said connection plate is coupled to said threaded member so as to prevent said threaded member from sliding excessively relative to said connection plate.

14. An apparatus for retracting at least one piston of a disc brake caliper, said apparatus comprising:
a top finger having an interior surface, an exterior surface, a base at one end, and a tip at an opposing end;
a bottom finger having an interior surface and an exterior surface, a base at one end, and a tip at an opposing end;
a central member for engaging the top finger interior surface and the bottom finger interior surface; and
a threaded member engaging said central member wherein rotation of said threaded member forces contact between said central member with both of said top and bottom fingers.

15. The apparatus of claim 14 wherein said top and bottom fingers have substantially parallel longitudinal axes formed along each tip and base; and wherein said central member is adapted to move between said arms longitudinally back and forth substantially parallel along the axes.

16. The apparatus of claim 14 wherein said central member is wedge shaped with a broad portion of said wedge positioned towards the tip of at least one of said top and bottom fingers.

17. The apparatus of claim 14 wherein said central member includes a threaded aperture to engage said threaded member.

18. The apparatus of claim 14 further comprising a crank coupled to said threaded member for rotating said threaded member.

19. The apparatus of claim 14 wherein at least one of said top and bottom fingers comprises a dove-tail.

20. The apparatus of claim 19 wherein said central member comprises at least one complimentary surface to form a dove-tail joint.

21. An apparatus for retracting at least one piston of a disc brake caliper, the caliper having at least one piston and a second surface disposed opposite the piston, wherein the caliper piston moves in a linear fashion defining a plane perpendicular to the movement of the caliper piston, said apparatus comprising:
a threaded shaft disposed substantially along the plane perpendicular, said shaft free to rotate substantially within the plane perpendicular;
a central member comprising a threaded aperture for receiving said shaft, wherein rotation of said shaft forces said central member to move along said shaft; and
wherein the rotation of said shaft forces the piston to retract.

22. The apparatus of claim 21 further comprising:
a top arm, said top arm having a tip at one end and a base at an opposing end, and having an interior surface and an exterior surface;
a bottom arm, said bottom arm having a tip at one end and a base at an opposing end, and having an interior surface and an exterior surface;
said top and bottom arms positioned with said interior surfaces facing one another;
said shaft positioned between said top and bottom arms; and
wherein rotation of said shaft forces said central member to engage said interior surfaces.

23. The apparatus of claim 21 wherein rotation of said shaft causes said central member to force at least portions of said top and bottom arms apart from one another, causing said exterior surfaces to engage at least the caliper piston.

24. A method of controlling a caliper piston position, said method comprising the steps on inserting at least two plate members between an exposed caliper piston and a second surface;
forcing a central member between the plate members to force the plate members to engage the caliper piston and the second surface; and
further forcing the central member between the plate members thus causing at least a portion of the plate members apart form one another so as to cause at least one of the plate members to push the caliper piston.

25. The method of claim 24 wherein the second surface is a second caliper piston.

26. The method of claim 24 wherein said step of forcing further comprises rotating a threaded member.

27. The method of claim 26 wherein said step of forcing further comprises pulling the central member towards a base of the two plate members.
